(19) United States
(12) Patent Application Publication
(10) Pub. No.: US 2002/0173952 A1
(43) Pub. Date: Nov. 21, 2002

(54) Coding

(76) Inventors: Stephan Oliver Mietens, Eindhoven (NL); Peter Hendrik Nelis De With, Eindhoven (NL); Christian Hentschel, Eindhoven (NL)

Correspondence Address: U.S. Philips Corporation, 580 White Plains Road, Tarrytown, NY, 10591, US

(21) Appl. No.: 10/042,447

(22) Filed: Jan. 8, 2002

(30) Foreign Application Priority Data
Jan. 10, 2001 (EP) 01200052.7

(51) Int. Cl. G10L 19/08

(52) U.S. Cl. 704/219

(57) ABSTRACT

The invention provides coding (20) a set of input values (S1) into a set of coefficients by use of a given algorithm, by selecting (201) coefficients to be calculated, out of a total set of possible coefficients that can be calculated by the given algorithm given the set of input values, in which selecting higher priority is given to coefficients which require a lower calculation cost compared to other coefficients, and by calculating (201) the selected coefficients to obtain the set of coefficients. Preferably, for a given coefficient the calculation cost is at least partly based on an amount of calculation steps that is required to calculate the given coefficient reduced with an amount of calculations that can be shared with the calculation of other selected coefficients, and wherein in the step of calculating results of shared calculation steps are re-used in calculating (201) other coefficients which share the shared calculation steps.

The invention relates to coding a set of input values into a set of coefficients by use of a given algorithm. This algorithm may be a Discrete Cosine Transformation (DCT), which algorithm is widely used in the field of image and video coding.

Pao and Sun [5] disclose that digital video coding standards such as H.263 and MPEG are becoming more and more important for multimedia applications. Due to the huge amount of computations required, there are significant efforts to speed up the processing of video encoders. Previously, the efforts were mainly focused on the fast motion-estimation algorithm. However, as the motion-estimation algorithm becomes optimized, to speed up the video encoders further other functions such as discrete cosine transform (DCT) and inverse DCT (IDCT) need be optimized. Pao and Sun propose a theoretical model for DCT coefficients. Based on this model, it is shown that the variances of the DCT coefficients can be represented as a function of the minimum mean absolute error (MMAE) after motion-compensated prediction. An adaptive method with multiple thresholds is derived from the statistical model to reduce the computations of DCT, IDCT, quantization and inverse-quantization. Pao and Sun further present a DCT approximation algorithm that can further speed up the calculations of DCT when the quantization step is large. An improvement in the processing speed can be achieved with negligible video-quality degradation.

An object of the invention is to support scalability of a given algorithm. To this end, the invention provides a method and device for coding a set of input values into a set of coefficients, a method and device for inverse transforming, a video system, a signal, a storage medium, a method and device for determining a calculation cost of a given algorithm, a database, and a computer program as defined in the independent claims. Advantageous embodiments are defined in the dependent claims.

Scalability means, inter alia, that quality can be exchanged with algorithm complexity or computational power: a loss of quality can be excepted in exchange for a reduction in algorithm complexity or computational power, vice versa.

A first embodiment of the invention provides coding a set of input values into a set of coefficients by use of a given algorithm, the method comprising: selecting coefficients to be calculated, out of a total set of possible coefficients that can be calculated by the given algorithm given the set of input values, in which selecting higher priority is given to coefficients which require a lower calculation cost compared to other coefficients, and calculating the selected coefficients to obtain the set of coefficients. By selecting the coefficients which require a lower calculation cost, a higher number of coefficients is calculated given a limited number of calculation steps or a limited time period. The number of calculated coefficients is related to the quality.

The invention is especially advantageous for algorithms that transform input values in a first domain (e.g. a temporal or spatial domain) into coefficients in a second domain (e.g. a frequency domain). A coefficient in the second domain may contain information on all values in the first domain, but only at a given level other than other coefficients. In this case, if more coefficients are available, a more accurate representation of the values in the first domain can be given. The coding is advantageously a video coding, wherein the input values form a block of pixel values, and the coefficients are transform coefficients selected out of a block of possible transform coefficients.

In an advantageous embodiment of the invention, for a given coefficient the calculation cost is at least partly based on an amount of calculation steps that is required to calculate the given coefficient reduced with an amount of calculations that can be shared with the calculation of other selected coefficients, and wherein in the step of calculating results of shared calculation steps are re-used in calculating other coefficients which share the shared calculation steps. By selecting those coefficients that require a lower calculation cost while taking into account the number of calculation steps that can be shared leads to a more optimal selection. Given limited resources, more coefficients can be calculated in this way. In a practical embodiment, in the calculation of the selected coefficients, intermediate results of shared calculation steps are stored in a memory and retrieved for re-use in calculating other coefficients when necessary.

In the selecting step, the number of coefficients to be calculated can be maximized given a maximum total calculation cost. In this embodiment a maximum quality is reached given the limited computational power. In this embodiment, the order of computation after selection may be arbitrary. Alternatively, given a desired number of coefficients to be calculated, the minimal required calculation cost can be determined. This may be useful in allocating calculation resources to the given algorithm relative to other algorithms or applications.

According to an advantageous embodiment, in addition to already calculated coefficients, a repeated selection of a next coefficient is performed until a stop criterion is met, for which next coefficient the calculation cost is minimal compared to other possible coefficients which are not yet calculated. In this embodiment ‘on-the-fly’ computation is possible, wherein the calculation is stopped when a computation limit or a certain time period has been reached. The algorithm can be reprogrammed to process the calculation steps in this specific order until a (time) limit is reached. Within this (time) limit, results can be updated from time to time. The algorithm is now independent of the computer system used, which can have an arbitrary computation power. The algorithm will calculate as many coefficients as possible within the given (time) limit and possible other constraints. Also in this embodiment the, the calculation cost is preferably at least partly based on the amount of calculation steps required to calculate the next coefficient reduced with an amount of calculation steps that are shared between the calculating of the next coefficient and calculation steps already performed for already calculated coefficients.

The invention is advantageously applied in a programmable video architecture. In this embodiment, a scalable (MPEG) coding algorithm is provided that features scalable video quality with respect to available computational power, which power may depend on the desired application. Given a limited computational power, this embodiment still preserves the quality as good as possible. One of the time-consuming basic algorithms of video processing applications is the calculation of the Discrete Cosine Transformation (DCT), but the inventions is also applicable to other algorithms. In the case of a transform algorithm, at a given computational limit, a maximum number of transform coefficients is calculated within the given calculation limit.

In a preferred embodiment of the invention, a scan order is used which is at least partly determined by which coefficients are calculated. Such a scan order may be transmitted to the decoder, e.g. per frame. This allows adapting the scan order per frame, which is advantageous in encoder processing and in bit-rate. The specific scan order is transmitted per frame and is therefore present in the transmitted signal. If all calculated coefficients are present in the transmitted signal, an End Of Block (EOB) may be inserted in the transmitted signal to indicate that for the given block no more coefficients are transmitted.

In an alternative embodiment of the invention, a predetermined scan order is used such as the zig-zag scan or alternatively the alternate scan both defined in MPEG, wherein a predetermined value is put in the resulting bit-stream for the non-calculated transform coefficients. This predetermined value is zero in a practical embodiment. The signal according to this embodiment of the invention will therefore have a specific pattern of zeros depending on the amount of transform coefficients that could have been calculated given limited computational power. In the case of low bit-rate, a lot of zeros is non-optimal. Also in this embodiment, an MPEG compliant decoder can decode the transmitted signal. Because a specific selection of possible transform coefficients is calculated, the result of this embodiment of the invention is discernable in the transmitted signal.

Favorable computation and/or scan orders may be determined off-line for a given transform algorithm, which favorable order is stored in a database (e.g. a look-up-table) in the encoder. The computational order need not to be the same as the scan order, but to save memory it is preferred that they are similar. In the case a non-standard scan order is used, an indication of which scan order has been used should be inserted. However, when the same database is also stored in the decoder, which is preferred, it is not necessary to transmit the order of the coefficients or the database/look-up-table to the decoder. In this case an index suffices which indicates which scan order out of a set of scan orders has been used in the encoder. In the case only one predetermined scan order is used, the scan order need not to be transmitted.

In the encoder, based on the available calculated transform coefficients, a scan order of the coefficients may be determined which is the most favorable for use in a decoder. Depending on how many coefficients can be buffered in the decoder, it is advantageous to transmit the transform coefficients in an order approximately similar to the most efficient computation order in the decoder. The decoder advantageously decodes the coefficients on the fly individually or per group of coefficients in the order as present in the transmitted signal.

Advantageously, at least one additional criterion is used in selecting the transform values to be calculated. Because some coefficients are more important for picture quality than others, priority setting between coefficients is useful. The priority can for example be set by multiplying the calculation cost in the database by a priority function of any sort, or by sorting the coefficients into different priority groups that give a process order per group. Depending on different types of image blocks, different priority levels can be chosen for the algorithm output, to find input-dependent calculation styles.

Preferably, one priority criterion might be based on how often the coefficient value is zero (after quantization). Coefficients that are often zero should get a lower priority. In a decoder, adapting a computation order of the coefficients depends on the coefficients received and how many of these coefficients can be buffered.

An inverse transformation operation may in the context of this invention also be construed as a transformation operation. In this case, the input values are formed by the coefficients and a selection is made between possible output values, e.g. pixel values. Non-calculated pixel values may be filled in by a predetermined value or a may be derived from surrounding pixel values, e.g. by averaging. Alternatively, a selection is made out of the coefficients which are input to the algorithm to calculate the output values. Also in this case a calculation cost is minimized, not by selecting which of the output values to calculate, but by selecting which of the available/received transform values are used as input to the algorithm to calculate the pixel values. If not all available transform values can be used due to the limitation in calculation steps that can be performed, the output values will be less accurate, but in the case of an image still a value is obtained for any pixel of the image (block).

The invention further relates to a video system comprising at least an encoding device according to an embodiment of the present invention, and a decoding device. An example of such a video system is a closed system for digitally storing video material on a Hard Disc Drive (HDD). Other examples are video conferencing systems, digital hand-held cameras, etc. In the case the video material is analog the video system additionally comprises an analog to digital converter. If the encoder in this video system produces an MPEG compliant bit-stream a standard decoder may be used. Advantageously, the decoder in the video system is a decoder according to an embodiment of the present invention.

The invention further relates to a method of analyzing a calculation cost of an algorithm. The analysis returns a database of a calculation cost as a function of coefficients. With this database, a list of coefficients is deductible which provides information on which coefficients can be calculated within a given calculation limit. Such a database can be used in (de-)coding according to embodiments of the present invention.

The aforementioned and other aspects of the invention will be apparent from and elucidated with reference to the embodiments described hereinafter.

In the drawings:

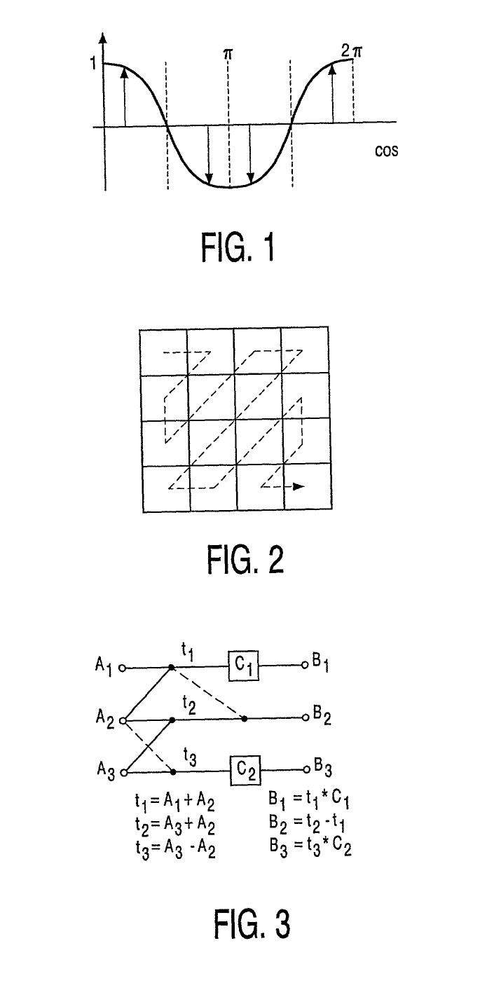

FIG. 1 shows the periodicity of the cosine function;

FIG. 2 shows the zig-zag scan order as used in H.263 and MPEG;

FIG. 3 shows a calculation from inputs A to outputs B according to an embodiment of the invention;

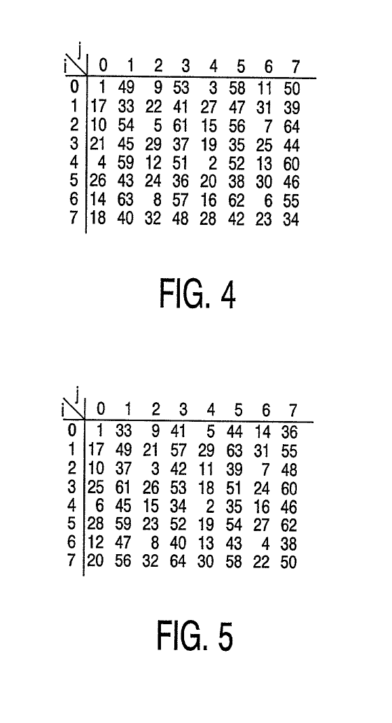

FIG. 4 shows a calculation order of coefficients in a DCT matrix according to an embodiment of the invention;

FIG. 5 shows a calculation order of coefficients in a DCT matrix according to an embodiment of the invention which takes into account an additional priority for the upper left comer of the matrix; and

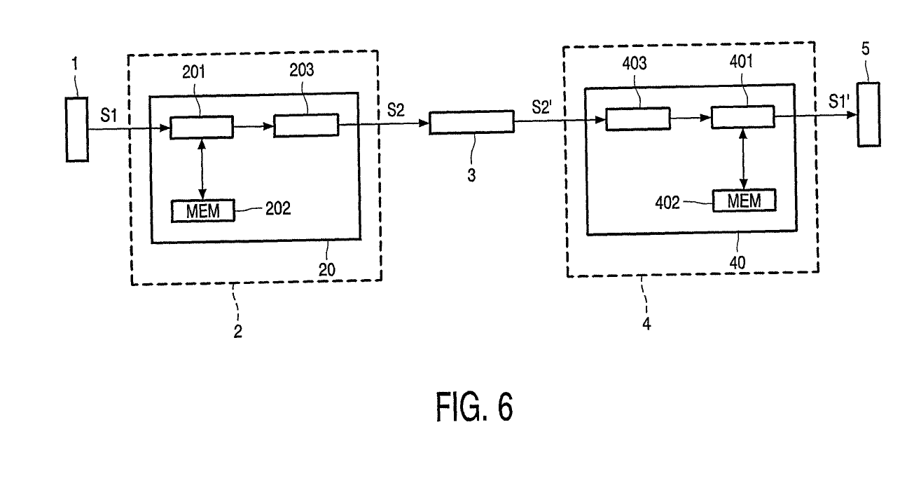

FIG. 6 shows a video system according to an embodiment of the invention.

The drawings only show those elements that are necessary to understand the invention.

For a better understanding of the invention, some basic theory on the DCT transformation is given first. The DCT transforms the luminance and chrominance values of small square blocks of an image to the transform domain. Afterwards, all coefficients are quantized, and the signal concentration into a small amount of coefficients ensures that the whole image can be saved with less data than the original.

For a given image block, represented as a 2D data matrix {x[i, j];i, j=0, 1, . . . , N−1}, the 2D DCT matrix {X[i,j];i,j=0,1, . . . , N−1} is given by

$$X [ m , n ] = \frac{2}{N} * u ( m ) * u ( n ) * {{\sum }^{N - 1}}_{i = 0} {{\sum }_{j = 0}}^{N - 1} x [ i , j ] * cos \frac{( 2 i + 1 ) m * π}{2 N} * cos \frac{( 2 j + 1 ) n * π}{2 N} \\ where \\ u ( k ) = \{ \begin{matrix}\frac{1}{\sqrt{2}} & if k = 0 \\ 1 & otherwise\end{matrix} \qquad ( 1 )$$

To reduce the complexity of Equation (1), the row-column method is often used. With this method, each row and column of an image block is transformed separately by a 1D-DCT. For a given 1D data vector {x[i];i=0,1, . . . , N−1}, the 1D-DCT vector {X[i];i=0,1, . . . , N−1} is defined by

$$X [ n ] = \sqrt{\frac{2}{N}} * u ( n ) * {\sum }_{i = 0}^{N - 1} x [ i ] * cos \frac{( 2 i + 1 ) n * π}{2 N} \qquad ( 2 )$$

Both Equations (1) and (2) have the form of:

Output=Const* InputMatrix* CosMatrix (3)

The constant part of Equation (3) can be merged into a later quantization step where transformed coefficients are removed for data compression purposes. Of course, the input data cannot be modified. The interesting third part is the cosine matrix. Transformations of this matrix are based on the periodicity of the cosine function. The cosine function is periodic, which means that results of the function repeats every 2π: cos(α)=cos(n*2π+α),n ∈Z Furthermore, the cosine function is anti-periodic over π, which means that results of the function repeat every π, but the sign changes: cos(α)=(−1)ⁿ*cos(n*π+α);n ∈Z FIG. 1 shows the plot of the cosine function, where four arrows are marked that have the same absolute value.

Most known DCT algorithms are designed for maximal video quality. Different strategies can be found to reduce the complexity of the DCT computation by mathematical transformations of Equation (1) or (2): Lee and Huang [1] reduce the calculation of the cosine matrix to equivalent sub-problems of a lower complexity. They normalize each angel α of the cosine matrix to 0≦|α|<0.57π and therefore a 2″×2″-DCT is reduced to 2^{n-1×2}ⁿ⁻¹-DCT's of lower complexity. Cho and Lee [2] found data dependencies between two cosine matrixes given in Equation (1) to represent one of the matrixes as function of the other matrix. Therefore, the 2D-transformation has been reduced to a 1D-transform, where the selection of the 1D-DCT algorithm is free of choice. Arai, Agui and Nakajima [3] deduce the DCT from a Discrete Fourier Transform (DFT), where several multiplication's can be absorbed in later quantization step.

Further, algorithms are known which reduce the computation complexity of the DCT to speed up calculation time, whereby a loss of video quality is accepted: Merhav and Vasudev [4] developed a calculation scheme for DCT and inverse DCT (IDCT). The main idea is to exchange all multiplications with shift operations and compensate the resulting error as good as possible in a later quantization step with no additional cost. Pao and Sun [5] made statistical analysis of encoding different video sequences with the video coding standard H.263. This coding standard saves an image block after the calculation of the DCT in a zigzag order as shown in FIG. 2, until all non-zero values have been saved. The remaining zeros are replaced by an end-of-block (EOB) sign. From the analysis, variances of the DCT coefficients can be represented as a function of the minimum mean absolute error (MMAE), which is taken after a motion-compensated prediction. Depending on this function and the quantization parameter of video coding standard H.263, thresholds have been measured to process an image block in different ways. Either the DCT is calculated for all 64 coefficients, or for an approximate 4×4 low frequency DCT, or for the upper left coefficient (the value only, or the DCT is not performed at all.

In the following, an embodiment of the invention is described wherein a specific computation order of the DCT coefficients is used depending on the DCT algorithm. After a computation step, the list of remaining coefficients is sorted such that in the next step the coefficient is computed having the lowest computation cost. In this case, the computation order gives a design rule for the DCT algorithm to maximize the number of coefficients within the given reduced computation power. Although this section concentrates on calculating a DCT, the matter described is also applicable to other algorithms, like the Inverse Discrete Cosine Transform (IDCT).

The approaches by Merhav and Vasudev [4] and Pao and Sun [5] already accept of loss of quality for saving calculations. However, both approaches do not consider the basic DCT algorithm to take into account calculations that are shared in calculating respective transform coefficients.

The knowledge of the basic DCT algorithm is important to find the best strategy for scaling it to lower video quality within given calculation effort and/or time constraints. As a result, a specific algorithm is modified by eliminating several calculations and thus coefficients. The results of the algorithm then will have the best quality possible within the given constraints, because as many coefficients are calculated as possible. It is important to find out what calculations can be eliminated to keep a maximum of coefficients for the best possible video quality. Because the DCT algorithms process video data in different ways, the algorithm used for a certain application should be analyzed closely.

The DCT algorithm is analyzed to find out the number of calculations, which are needed to obtain specific DCT coefficients. This analysis explores data dependencies between calculation nodes within the algorithm. A database can be build for every calculation step, when going from the input values to the finally transformed coefficient and what calculations are still needed to obtain another coefficient. If a computation limit is set, it is preferable to calculate coefficients that share calculation steps. The number of coefficients is then maximized with minimum effort.

The analysis step and the advantage of this method is explained with an example of a short calculation given in FIG. 3. This example shows a calculation with three intermediate results t₁, t₂ and t₃. The calculation cost for coefficients B₁, B₂ and B₃ are determined by counting all operations that are needed to calculate each of the coefficients starting from the input values. For example, B₁ is calculated by B1=t₁, * C₁=(A₁+A₂) * C₁, and therefore consists of one addition (within t₁) and one multiplication. This information is stored in a database as given in Table 1, where one multiplication is set to be equivalent to three additions as an example.

TABLE 1
Calculation cost according to an embodiment of the invention.
One addition is counted as one operation, one multiplication
is counted as three operations.

| overall | | | | | | |
|---|---|---|---|---|---|---|
| calculations | t₁ | t₂ | t₃ | B₁ | B₂ | B₃ |
| additions | 1 | 1 | 1 | t₁ + 0 = 1 | t₁ + t₂ + 1 = 3 | t₃ + 0 = 1 |
| multipli- | 0 | 0 | 0 | t₁ + 1 = 1 | t₁ + t₂ + 0 = 0 | t₃ + 1 = 1 |
| cations | | | | | | |
| operations | 1 | 1 | 1 | 1 + 1 * 3 = 4 | 3 + 0 * 3 = 3 | 1 + 1 * 3 = 4 |
| count | | | | | | |

Using this database, we can focus on finding the next DCT coefficient that needs the least operations, depending on the calculations already done. This will give an algorithm-dependent calculation order of the coefficients. In the example given in FIG. 3, B₂ will be calculated in a first step, because it only needs three operations. Coefficients B₁ and B₃ have the same calculation cost, so there seems no difference whether to calculate B₁ or B₃ first. However, coefficients B₁ and B₂ share node t₁, which leads to less remaining calculation cost for B₁ than B₃ in the second step. This can be seen in Table 2, where the database of Table 1 has been updated by the information, that B₂ has been calculated.

TABLE 2
Remaining calculation cost after B₂ has been calculated.

| remaining calculations | t₁ | t₂ | t₃ | B₁ | B₂ | B₃ |
|---|---|---|---|---|---|---|
| additions | 0 | 0 | 1 | 0 | 0 | 1 |
| multiplications | 0 | 0 | 0 | 1 | 0 | 1 |
| operations count | 0 | 0 | 1 | 3 | 0 | 4 |

Therefore, it is preferable to calculate the given coefficients in this order: B₂, B₁, B₃. If the computation power is reduced to six operations for this example, coefficients B₂ and B₁ can be calculated. With a calculation order of B₂, B₃, B₁, only B₂ would be calculated, because the first two coefficients B₂ and B₃ need seven operations together.

The approach explained in this section has been used to find a calculation order for the 2D-DCT algorithm by Cho and Lee [2] including the 1 D-DCT algorithm by Arai, Agui and Nakajima [3]. The result is shown in FIG. 4.

The calculation order can be improved, if a quantization step after the calculation of the DCT is considered. In most cases, the important values of a transformed image block can be found in the upper left comer of the block. The quantization step removes less important values for data compression purposes. Therefore, the coefficients can be combined with a priority function to prefer coefficients in the upper left comer. The calculation order given in FIG. 5 was found by multiplying the number of operations for coefficient C[i,j] (stored in the generated database) with a priority function p(i,j)=i*2+|i-j|+1. Function p was found by some experiments and seems to be suitable for a first implementation.

Table 3 shows how this variation leads to another calculation order. Here, one multiplication is set to be equivalent to three additions and the first two coefficients C₀₀ and C₄₄ have already been calculated. It is clear that the next coefficient to be calculated is C₀₄ without using a priority function, but C₂₂ when using priority function p.

TABLE 3
Decision of next coefficient to be calculated. C₀₄ is preferred
without using a priority function, C₂₂ when using priority function p.

| | C₀₄ | C₂₂ |
|---|---|---|
| additions left to calculate coefficient | 7 | 9 |
| multiplications left to calculate coefficient | 4 | 4 |
| operations count-without priority function | 19 | 22 |
| priority function p(i,j) | 13 | 9 |
| operations count-scaled with priority function | 247 | 189 |

A further enhancement is that the calculation order can be optimized with a priority function, which is designed for certain contents of an image block. For example, image blocks are categorized in three different groups: image blocks containing horizontal lines, vertical lines or blocks without a clear structure. In each of these three groups, the DCT will prefer specific coefficients to describe the original image block. This can be expressed with a priority function. A short pre-analysis of each image block can be performed or taken from other functions that do similar analysis, to ensure that the most important coefficients are calculated first.

Within the MPEG standard, a zigzag order as shown in FIG. 2 is used to code DCT coefficients, because the most important values are normally found in the upper left comer of the quantized block. Using this zigzag order as a calculation order, many time-consuming calculations have to be done at the beginning of the computation to obtain the first coefficients, because these values depend on different inputs and no intermediate result can be reused. For a reduced computation power, this would result in fewer coefficients to be used afterwards. Thus finding the best computation order is useful.

The operations count for a given number of coefficients of the zigzag order has been compared with the calculation-optimized order presented in this section. It can be noticed that the calculation-optimized order leads to significantly more coefficients calculated, which results in a better video quality. The SNR improves between 1-5 dB.

The method presented is practical for scalable algorithms in many ways. Instead of presenting a specific quantity of coefficients to be calculated, it can be used for automatic quality scaling. For example, running a real-time video application on a PC with low computation power may fail, because this PC is not able to complete all calculations in real-time. In this case, the video processing will be aborted or show hick-ups. To solve this problem, the video processing software can update a list of already calculated coefficients, until the next block has to be processed or a user-defined time limit is reached. With this solution, full screen and full temporal viewable video can be ensured.

This embodiment of the invention provides an advantageous method for computing the DCT in a special order to support scalability. This is achieved by analyzing each calculation step of a DCT algorithm to find coefficients that should computed next with minimum effort. The method maximizes the SNR of the picture during the computation by obtaining a high amount of DCT coefficients up to the point of consideration.

The computation method can be enhanced by various features such as a prioritization function, which favors the computation of low-frequency coefficients so that it fits better with MPEG coding after performing a DCT. The technique can successfully implemented for an IDCT as well.

FIG. 6 shows a video system comprising a video source 1, a transmitter 2, a communication channel or storage medium 3, a receiver 4 and a display device 5. The video source 1 may be a camera or the like and furnishes a video source signal S1 to the transmitter 2. The transmitter 2 comprises a video encoder 20. The video encoder comprises a calculation unit 201, a memory 202 and an output unit 203. The calculation unit calculates from the input samples of the video source signal S1 a set of transform coefficients that are included in the coded output signal S2 which is transmitted over the communication channel 3 or alternatively stored in the case the communication channel 3 is a storage medium. The video encoder 20 further comprises a memory 202, which is used for storing intermediate results of calculations in the calculation unit 201. The intermediate results are typically results from calculations that are shared between the calculations of respective transform coefficients that are calculated in the calculation unit 201. The memory 202 can further be used to store a scan order or computation order of the transform coefficients. The output unit 203 formats the transform values into a suitable format for transmission. In video encoders such as MPEG encoders, transform coefficients are usually quantized to reduce the number of bits necessary to represent the transform value. In FIG. 6, necessary quantize operations are assumed to be performed in the calculation unit 201. Although not shown in FIG. 6, MPEG encoders usually also comprise elements for performing motion estimation and compensation for predictively coding pictures. The output unit 203 may perform operations like variable length encoding, multiplexing and channel coding.

According to an embodiment of the invention, the computation order is algorithm dependent, although the computation order may additionally be determined by a priority function, which takes other conditions into account, as described earlier. The scan order may be identical to the computation order, but that is not necessary. In any case, the decoder should be synchronized with the encoder on the scan order. The decoder may use another computation order than the encoder, because for a decoding algorithm(s) another computation may be more efficient.

The receiver 4 comprises a decoder 40. The video decoder 40 comprises an input unit 403, a calculation unit 401 and a memory 403. The input unit receives a coded video signal S2′ from the communication channel or storage medium 3. The coded video signal S2′ will normally be identical to the signal S2, although S2′ may contain errors introduced by the communication channel or storage medium 3. The input unit 403 may perform operations like variable length decoding, demultiplexing and channel decoding, normally inversely to the operations performed in the output unit 203. The calculation unit 401 performs an inverse transformation to calculate pixel values from the received transform coefficients. The pixel values are included in an output signal S1′ which is a reduced quality version of the video source signal S1. The output signal S1′ is displayed on the display unit 5.

The decoder 40 may be a standard decoder. Advantageously, the decoder 40 is a decoder according to an embodiment of the invention. As already explained, a selection may be made between the available transform coefficients which are input to the inverse transform, in which selection higher priority is given to transform coefficients which require a lower calculation cost than other coefficients, also based on the amount of calculation steps required for the selected transform coefficients and the amount of calculation steps that can be shared. For this purpose, the memory 402 may contain a database which indicates which of the available transform coefficients may be calculated given a maximum computation power. In a further embodiment, the memory 402 stores a scan order used by an encoder according to an embodiment of the invention, which scan order is determined by which coefficients are calculated or which scan order is even approximately similar to the computation order in the encoder.

The invention is advantageously applied in applications that need real-time video encoding on one hand, but have further restrictions on the other hand, such as:

Video conferencing systems which have a low video resolution and often communicate the video stream via a narrow-bandwidth connection. This leads to communication delays between the conference participants, which delay has to be minimized. Furthermore, video conferencing is an example where video with sufficient temporal resolution is more important than high spatial video quality.

Digital hand-held video cameras which should be handy, cheap and of good quality to be accepted by the consumer. These cameras have a medium resolution and therefore need more complex video processing algorithms than video conferencing systems. To limit the cost of a camera, these algorithms should be programmable in software or should lead to simple hardware solutions.

Televisions with general-purpose computation power. Part of the available computation power can be saved by scaling the given algorithms for video applications to lower complexity, therefore enabling the television to perform other tasks in parallel. Otherwise, the video application could block other applications of interest.

The invention is further applicable to parametric coding schemes, wherein input values are coded into a set of parameters. In the claims, coefficients should be construed as parameters in these coding schemes.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

### Bibliography

[1] P. Lee and F. -Y. Huang, “Restructured Recursive DCT and DST Algorithms,” IEEE Transaction on Signal Processing, vol. 42, pp. 1600-1609, July 1994

[2] N. I. Cho and S. U. Lee, “Fast Algorithm and Implementation of 2-D Discrete Cosine Transform”, IEEE Transactions on Circuits and Systems, vol. 38, pp.297-305, March 1991

[3] T. A. Y. Arai and M. Nakajiama, “A Fast DCT-SQ Scheme for Images” Trans. on the IEICE, vol. 71, p. 1095, November 1988

[4] N. Merhav and B. Vasudev, “A multiplication-free approximate algorithm for the inverse discrete cosine transform” Proceedings IEEE International Conference of Image Processing, Kobe, Japan, October 1999

[5] I. Pao and M. Sun, “Modeling dct coefficients for fast video encoding”, IEEE Transactions on Circuits and Systems for Video Technology, vol. 9, pp. 608-616, June 1999

1. A method of coding (20) a set of input values (S1) into a set of coefficients by use of a given algorithm, the method comprising:
selecting (201) coefficients to be calculated, out of a total set of possible coefficients that can be calculated by the given algorithm given the set of input values, in which selection priorities depend on calculation costs of the respective possible coefficients, and
calculating (201) the selected coefficients to obtain the set of coefficients.

2. A method as claimed in claim 1, wherein for a given coefficient the calculation cost is at least partly based on an amount of calculation steps that is required to calculate the given coefficient reduced with an amount of calculations that can be shared with the calculation of other selected coefficients, and wherein in the step of calculating (201) results of shared calculation steps are re-used in calculating (201) other coefficients which share the shared calculation steps.

3. A method as claimed in claim 1, wherein in the selecting step (201) the number of coefficients to be calculated is maximized given a maximum total calculation cost.

4. A method as claimed in claim 1, wherein in the selecting step (201) a predetermined number of coefficients is selected.

5. A method as claimed in claim 1, the method comprising repeatedly selecting (201) a next coefficient to be calculated until a stop criterion is met, for which next coefficient the calculation cost is minimal compared to other possible coefficients which are not yet calculated.

6. A method as claimed in claim 5, wherein the calculation cost is at least partly based on the amount of calculation steps required to calculate the next coefficient reduced with an amount of calculation steps that can be shared between the calculating of the next coefficient and calculation steps already performed for already calculated coefficients.

7. A method as claimed in claim 1, wherein at least one additional criterion is used in selecting (201) the coefficients to be calculated.

8. A method as claimed in claim 7, wherein the calculation cost is weighted (201) by a priority function which represents the at least one additional criterion.

9. A method as claimed in claim 1, the method further comprising:
including (203) the set of coefficients in an output signal (S2) according to a scan order which is at least partly determined by the calculated coefficients, and
including (203) information about the scan order in the output signal (S2).

10. A method as claimed in claim 1, wherein the set of coefficients is included (203) in an output signal (S2) according to a predetermined scan order, and wherein for non-calculated coefficients in the predetermined scan order a predetermined value is used (203).

11. A method as claimed in claim 10, wherein the predetermined value is zero.

12. A method as claimed in claim 1, wherein the coefficients to be calculated are obtained from a database (202) comprising information on the calculation costs of the respective possible coefficients.

13. A method as claimed in claim 12, wherein the calculation costs information in the database (202) is available in the form of a list which indicates which coefficients can be calculated as a function of a given maximum of available calculation steps.

14. A device for coding (20) a set of input values (S1) into a set of coefficients by use of a given algorithm, the device comprising:
means (201) for selecting coefficients to be calculated, out of a total set of possible coefficients that can be calculated by the given algorithm given the set of input values, in which selection priorities depend on calculation costs of the respective possible coefficients, and
means (201) for calculating the selected coefficients to obtain the set of coefficients.

15. A method of inverse transforming (401) a set of coefficients (S2) into a set of output values (S1′) by use of a given algorithm, the method comprising:
selecting (401) respective coefficients out of a total set of available coefficients for use as input in calculating the values by the given algorithm, in which selection priorities depend on calculation costs of the respective available coefficients,
calculating (401) the values from the selected coefficients.

16. A method as claimed in claim 15, wherein for a given coefficient the calculation cost is at least partly based on an amount of calculation steps that is required to calculate the values with the given coefficient as input to the algorithm reduced with an amount of calculations that can be shared with calculations based on other coefficients as input to the algorithm, and in which calculating, results of shared calculation steps are re-used in other calculations which share the shared calculation steps.

17. A device (40) for inverse transforming a set of coefficients (S2′) into a set of output values (S1′) by use of a given algorithm, the device comprising:
means (401) for selecting respective coefficients out of a total set of available coefficients for use as input in calculating the values by the given algorithm, in which selection priorities depend on calculation costs of the respective available coefficients,
means (401) for calculating the values from the selected coefficients.

18. A signal (S2,S2′) including a set of coefficients representing a set of values, the set of coefficients being a sub-set of a total set of possible coefficients that could have been calculated by a given algorithm from the set of values, wherein the respective coefficients in the signal are those coefficients for which a calculation cost is lower compared to non-calculated coefficients.

19. A signal (S2,S2′) as claimed in claim 18, wherein the coefficients are present in the signal according to a scan order determined by the calculated coefficients, the signal further including information about the scan order,

20. A signal (S2,S2′) as claimed in claim 18, wherein the coefficients are included in the signal according to a predetermined scan order, wherein for the non-calculated coefficients a predetermined value is included in the transmitted signal.

21. A storage medium (3) on which a signal (S2,S2′) according to claim 18 has been stored.

22. A method of decoding (40) a signal (S2,S2′) according to claim 19, the method comprising:
obtaining (403) from the signal the information about the scan order determined by the calculated coefficients,
obtaining (403) from the signal the coefficients by using the obtained scan order, and
calculating (401) the coefficients.

23. A device (40) for decoding a signal (S2,S2′) according to claim 19, the device comprising:
means (403) for obtaining from the signal the information about the scan order determined by the calculated coefficients,
means (403) for obtaining from the signal the coefficients by using the obtained scan order, and
means (401) for calculating the coefficients.

24. Signal carrying a computer program for enabling a processor to carry out the method according to claim 1.

25. A storage medium on which a signal as claimed in claim 24 has been stored.
